(19) United States
(12) Patent Application Publication
(10) Pub. No.: US 2026/0092770 A1
(43) Pub. Date: Apr. 2, 2026

(54) DISTANCE MEASUREMENT DEVICE, DISTANCE MEASUREMENT METHOD, AND DISTANCE MEASUREMENT PROGRAM

(71) Applicant: Panasonic Intellectual Property Management Co., Ltd., Osaka (JP)

(72) Inventors: Masaharu FUKAKUSA, KUMAMOTO KEN (JP); Mayu TABA, OSAKA FU (JP); Shinzo KOYAMA, OSAKA FU (JP)

(21) Appl. No.: 19/113,314

(22) PCT Filed: Sep. 22, 2023
(86) PCT No.: PCT/JP2023/034528

§ 371 Date: Mar. 19, 2025

(30) Foreign Application Priority Data
Sep. 30, 2022 (JP) 2022-158285

(51) Int. Cl. G01B 11/14

(52) U.S. Cl. CPC G01B 11/14

(57) ABSTRACT

A projection unit projects pattern light on an area where a visual field of a first imaging unit and a visual field of a second imaging unit overlap each other. A measurement unit measures a distance to a surface to be measured onto which the pattern light is projected, based on a parallax between a first image obtained by the first imaging unit and a second image obtained by the second imaging unit. The pattern light is pattern light which includes a plurality of light regions with different hues and a plurality of light regions with the same hue and different levels of luminance, and in which a plurality of wide-area light regions are distributed in a predetermined pattern and a plurality of narrow-area light regions are distributed in another predetermined pattern in each of the plurality of wide-area light regions.

### TECHNICAL FIELD

The technique disclosed herein relates to a distance measurement technique.

### BACKGROUND ART

Patent Document 1 discloses a three-dimensional measurement system. In this system, an imaging unit includes a first imaging unit and a second imaging unit arranged away from each other. A first calculation unit calculates the parallax at a first feature point, using distance information based on a three-dimensional measurement method different from a stereo camera method by using at least one of images of an object captured by the first imaging unit and the second imaging unit. A second calculation unit calculates the parallax at a second feature point based on the stereo camera method by using both the images of the object captured by the first imaging unit and the second imaging unit. The second calculation unit specifies the three-dimensional shape of the object based on the parallax at the first feature point and the parallax at the second feature point.

### CITATION LIST

### Patent Document

Patent Document 1: Japanese Unexamined Patent Publication No. 2021-192064

### SUMMARY OF THE INVENTION

### Technical Problems

In the system as disclosed in Patent Document 1, when a surface to be measured for a distance includes a plain surface without any texture, it is difficult to perform the stereo matching (search for a corresponding point) on such a plain surface. It is thus difficult to measure accurately the distance to the surface to be measured.

### Solution to the Problems

The technique disclosed herein relates to a distance measurement device. The distance measurement device includes: a first imaging unit and a second imaging unit aligned so that visual fields of the first imaging unit and the second imaging unit overlap each other; a projection unit configured to project pattern light on an area in which the visual field of the first imaging unit and the visual field of the second imaging unit overlap each other; and a measurement unit configured to measure a distance to a surface to be measured onto which the pattern light is projected, based on a parallax between a first image obtained by the first imaging unit and a second image obtained by the second imaging unit, the pattern light being pattern light which includes a plurality of light regions with different hues and a plurality of light regions with the same hue and different levels of luminance, and in which a plurality of wide-area light regions are distributed in a predetermined pattern and a plurality of narrow-area light regions are distributed in another predetermined pattern in each of the plurality of wide-area light regions.

The technique disclosed herein relates to a distance measurement method using a first imaging unit and a second imaging unit aligned so that visual fields of the first imaging unit and the second imaging unit overlap each other; and a projection unit configured to project pattern light on an area in which the visual field of the first imaging unit and the visual field of the second imaging unit overlap each other. The distance measurement method includes: projecting the pattern light from the projection unit; obtaining a first image obtained by the first imaging unit and a second image obtained by the second imaging unit; and measuring a distance to a surface to be measured onto which the pattern light is projected, based on a parallax between the first image and the second image, the pattern light being pattern light which includes a plurality of light regions with different hues and a plurality of light regions with the same hue and different levels of luminance, and in which a plurality of wide-area light regions are distributed in a predetermined pattern and a plurality of narrow-area light regions are distributed in another predetermined pattern in each of the plurality of wide-area light regions.

The technique disclosed herein is directed to a distance measurement program for causing a computer to execute the distance measurement method described above.

### Advantages of the Invention

According to the technique disclosed herein, it is possible to measure accurately a distance to a surface to be measured even if the surface to be measured includes a plain surface.

### BRIEF DESCRIPTION OF THE DRAWINGS

FIG. 1 is a schematic diagram illustrating as an example a schematic configuration of a distance measurement device according to an embodiment.

FIG. 2 is a block diagram illustrating as an example a configuration of the distance measurement device according to the embodiment.

FIG. 3 is a block diagram illustrating as an example a functional configuration of a controller.

FIG. 4 is a schematic diagram for describing first search processing.

FIG. 5 is a schematic diagram for describing second search processing.

FIG. 6 is a schematic diagram illustrating projected pattern light as an example.

FIG. 7 is a schematic diagram illustrating a configuration of a filter as an example.

FIG. 8 shows graphs for describing output characteristics of each light source and transmittance characteristics of each filter region according to the embodiment.

FIG. 9 is a flowchart illustrating luminance adjustment processing as an example.

FIG. 10 is a flowchart illustrating distance measurement processing as an example.

FIG. 11 is a block diagram illustrating as an example a configuration of a distance measurement device according to a first variation of the embodiment.

FIG. 12 shows graphs for describing output characteristics of a light source and transmittance characteristics of each filter region according to the first variation of the embodiment.

FIG. 13 is a schematic diagram illustrating as an example a part of pattern light according to a second variation of the embodiment.

FIG. 14 is a schematic diagram illustrating as an example a part of a filter according to the second variation of the embodiment.

### DESCRIPTION OF EMBODIMENT

Now, an embodiment will be described in detail with reference to the drawings. The same reference characters are used to represent equivalent elements, and redundant explanations will be omitted.

### Distance Measurement Device

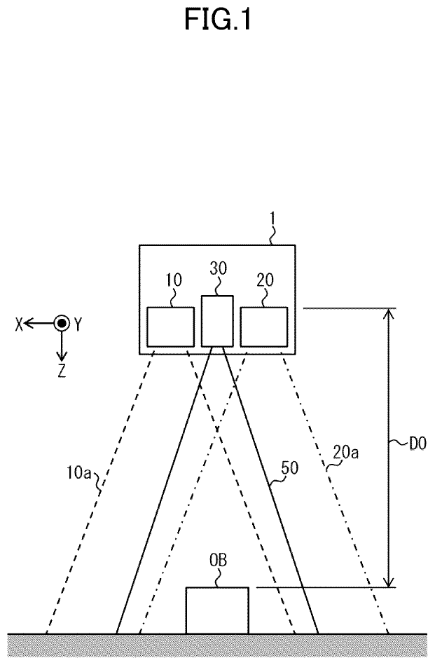

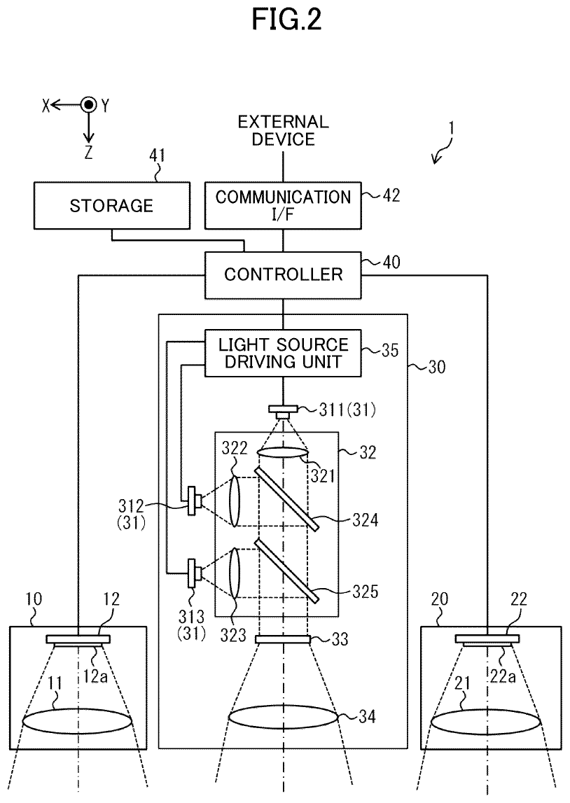

FIGS. 1 and 2 illustrate as an example a configuration of a distance measurement device 1 according to an embodiment. The distance measurement device 1 includes a first imaging unit 10, a second imaging unit 20, a projection unit 30, a controller 40, a storage 41, and a communication interface 42. The distance measurement device 1 measures a distance D0 to a surface to be measured. In this example, the surface to be measured is a surface of an object OB (e.g., the surface facing the first imaging unit 10 and the second imaging unit 20).

In the following description, the direction orthogonal to the X-axis direction is referred to as a “Y-axis direction,” and the direction orthogonal to both the X-axis direction and the Y-axis direction is referred to as a “Z-axis direction.”

### [Imaging Unit]

The first imaging unit 10 performs imaging of the range of a first visual field 10a. The second imaging unit 20 performs imaging of the range of a second visual field 20a. The first imaging unit 10 and the second imaging unit 20 are aligned so that their visual fields overlap each other. In this example, the first visual field 10a and the second visual field 20a are directed in the Z-axis direction, and the first imaging unit 10 and the second imaging unit 20 are aligned in the X-axis direction.

The area in which the first visual field 10a of the first imaging unit 10 and the second visual field 20a of the second imaging unit 20 overlap includes the surface to be measured (i.e., the surface of the object OB in this example). The first imaging unit 10 and the second imaging unit 20 are what is called stereo cameras, and simultaneously capture images of ranges of the visual fields (i.e., ranges to be imaged) at viewpoints different from each other.

The first imaging unit 10 captures a first image P10 by capturing an image of the range of the first visual field 10a at every predetermined time. The first imaging unit 10 includes a first imaging lens 11 and a first imaging element 12.

The first imaging lens 11 collects light from the visual field 10a of the first imaging unit 10 onto a first imaging surface 12a of the first imaging element 12. The first imaging lens 11 may be a single lens with a predetermined focal length, or a combination of a plurality of lenses.

The first imaging element 12 converts the light applied onto the first imaging surface 12a into electric signals. The first image P10 is obtained in this manner. The first imaging element 12 may be a monochrome image sensor. For example, the first imaging element 12 may be a CMOS image sensor or a CCD image sensor, for example.

The second imaging unit 20 captures a second image P20 by capturing an image of the range of the second visual field 20a at every predetermined time. The second imaging unit 20 has the same configuration as the first imaging unit 10. The second imaging unit 20 includes a second imaging lens 21 and a second imaging element 22. The second imaging lens 21 and the second imaging element 22 have the same configurations as the first imaging lens 11 and the first imaging element 12. The second imaging lens 21 has the same focal length as the first imaging lens 11. The second imaging element 22 has a second imaging surface 22a.

The second image P20 is the same size as the first image P10. The pixels of the second image P20 are the same size as the pixels of the first image P10. The second image P20 includes the same number of pixels as the first image P10.

The imaging direction of the first imaging unit 10 may be slightly inclined from the Z-axis direction toward the second imaging unit 20 (i.e., in a direction toward the second imaging unit 20). The imaging direction of the second imaging unit 20 may be slightly inclined from the Z-axis direction toward the first imaging unit 10 (i.e., in a direction toward the first imaging unit 10). The positions of the first imaging unit 10 and the second imaging unit 20 in the Z-axis direction and the Y-axis direction are the same.

### [Projection Unit]

The projection unit 30 projects pattern light 50 on an area where the first visual field 10a of the first imaging unit 10 and the second visual field 20a of the second imaging unit 20 overlap each other. In this example, the pattern light 50 is projected by the projection unit 30 in the Z-axis direction. The pattern light 50 is projected on a surface of the object OB (an example of the surface to be measured) included in the area where the first visual field 10a of the first imaging unit 10 and the second visual field 20a of the second imaging unit 20 overlap each other. The pattern light 50 will be described in detail later.

The projection unit 30 includes light sources 31, an optical system 32, a filter 33, a projection lens 34, and a light source driving unit 35.

Each light source 31 emits light to be used to generate the pattern light 50. In this example, the light sources 31 include first to third light sources 311 to 313. For example, the first light source 311 emits light in a wavelength range corresponding to “red” (e.g., 590 nm to 640 nm). The second light source 312 emits light in a wavelength range corresponding to “green” (e.g., 490 nm to 550 nm). The third light source 313 emits light in a wavelength range corresponding to “blue” (e.g., 430 nm to 490 nm). The first to third light sources 311 to 313 may be light-emitting diodes or other types of light sources, such as semiconductor lasers.

The optical system 32 guides the light emitted from each light source 31 to the filter 33. In this example, the optical system 32 includes first to third collimator lenses 321 to 323, a first dichroic mirror 324, and a second dichroic mirror 325.

The first to third collimator lenses 321 to 323 convert the light emitted from the first to third light sources 311 to 313, respectively, into substantially parallel light. The first dichroic mirror 324 transmits the light incident from the first collimator lens 321 and reflects the light incident from the second collimator lens 322. The second dichroic mirror 325 transmits the light incident from the first dichroic mirror 324 and reflects the light incident from the third collimator lens 323. This configuration combines the light emitted from the first to third light sources 311 to 313 and guides the combined light to the filter 33.

The filter 33 generates the pattern light 50. A configuration of the filter 33 will be described in detail later.

The projection lens 34 projects the pattern light 50 generated by the filter 33. The projection lens 34 may be a single lens or a combination of a plurality of lenses.

The light source driving unit 35 drives the light sources 31 (i.e., the first to third light sources 311 to 313 in this example) in response to the control by the controller 40. Specifically, the light source driving unit 35 drives the light source 31 based on a driving current value set by the controller 40 so that light with luminance corresponding to the driving current value be emitted.

### [Controller]

The controller 40 performs various types of processing. Specifically, the controller 40 obtains information and data from respective units of the distance measurement device 1 and performs the various types of processing based on the information and the data. The processing by the controller 40 will be described in detail later.

For example, the controller 40 includes a processor and a memory (i.e., a storage medium) that stores a program for operating the processor. When the program is executed by the processor, the various functions of the controller 40 are achieved. In other words, the controller 40 includes various functional blocks that achieve various functions. The controller 40 is an exemplary computer. The program is an example of the distance measurement program.

The controller 40 and the communication interface 42 may be each configured by a semiconductor integrated circuit including a field programmable gate array (FPGA). Alternatively, these may be each configured by another semiconductor integrated circuit, such as a digital signal processor (DSP), a graphics processing unit (GPU), or an application specific integrated circuit (ASIC).

### [Storage]

The storage 41 stores various information and data. In this example, the storage 41 stores the first image P10 obtained by the first imaging unit 10 and the second image P20 obtained by the second imaging unit 20, for example.

### [Functional Configuration of Controller]

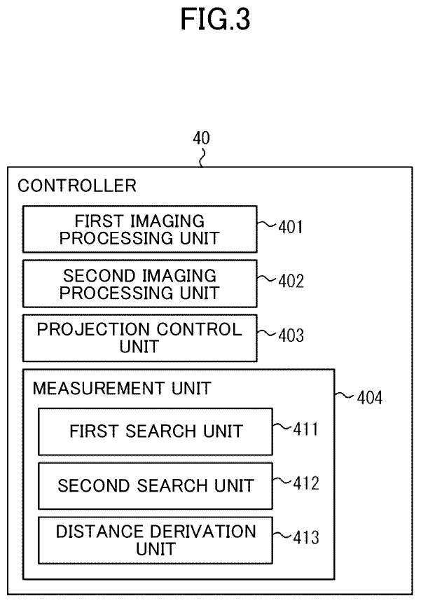

FIG. 3 illustrates a functional configuration of the controller 40 as an example. In this example, the controller 40 includes a first imaging processing unit 401, a second imaging processing unit 402, a projection control unit 403, and a measurement unit 404.

### <Imaging Processing Unit>

The first imaging processing unit 401 controls the first imaging element 12 of the first imaging unit 10. The first imaging processing unit 401 performs preprocessing, such as luminance correction and camera calibration, on the first image P10 (i.e., pixel signals) obtained by the first imaging element 12 of the first imaging unit 10. In this example, the first image P10 processed by the first imaging processing unit 401 is stored in the storage 41.

The second imaging processing unit 402 controls the second imaging element 22 of the second imaging unit 20. The second imaging processing unit 402 performs preprocessing, such as luminance correction and camera calibration, on the second image P20 (i.e., pixel signals) obtained by the second imaging element 22 of the second imaging unit 20. In this example, the second image P20 processed by the second imaging processing unit 402 is stored in the storage 41.

### <Projection Control Unit>

The projection control unit 403 controls the projection unit 30. Specifically, the projection control unit 403 controls the projection unit 30 to cause the projection unit 30 to project the pattern light 50.

In this example, the projection control unit 403 performs luminance adjustment processing. In the luminance adjustment processing, the projection control unit 403 adjusts the luminance of the light emitted from each light source 31 (e.g., each of the first to third light sources 311 to 313 in this example) so that the luminance of the light emitted from the light source 31 is not saturated. The luminance adjustment processing will be described in detail later.

### <Measurement Unit>

The measurement unit 404 measures the distance D0 to the surface to be measured onto which the pattern light 50 is projected, based on the parallax between the first image P10 obtained by the first imaging unit 10 and the second image P20 obtained by the second imaging unit 20. In this example, the measurement unit 404 includes a first search unit 411, a second search unit 412, and a distance derivation unit 413.

### <<First Search Unit (First Search Processing)>>

The first search unit 411 performs first search processing. In the first search processing, the first search unit 411 sequentially selects a wide-area reference block B11 from the first image P10 and searches the second image P20 for a wide-area corresponding block B21 corresponding to the wide-area reference block B11. Specifically, the first search unit 411 performs the following processing in the first search processing.

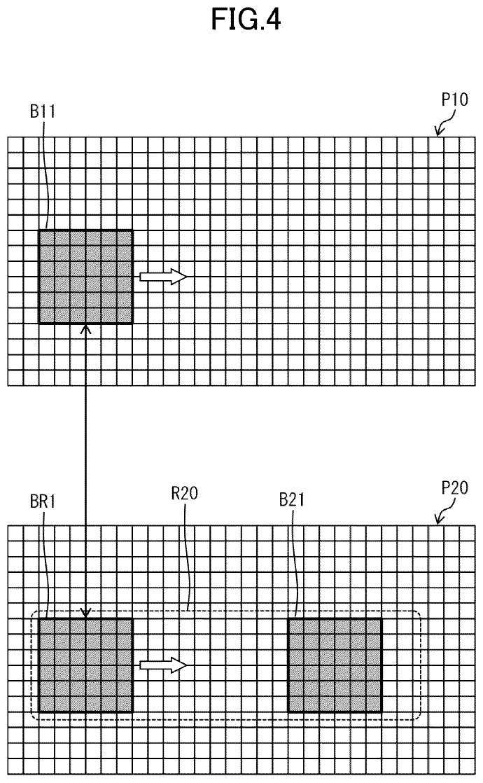

As shown in FIG. 4, the first search unit 411 sequentially selects the wide-area reference block B11 from the first image P10 by moving a pixel area, which is for selecting the wide-area reference block B11, by a predetermined amount (i.e., a first reference amount of movement) in the first image P10. The wide-area reference block B11 is a pixel block (i.e., a group of a plurality of pixels) serving as a reference point in searching for a corresponding point in the first search processing. In the example of FIG. 4, the wide-area reference block B11 includes 36 pixels in a matrix of six rows and six columns. The first search unit 411 then performs the following processing on each of the wide-area reference blocks B11 sequentially selected from the first image P10.

The first search unit 411 sequentially selects a wide-area referenced block BR1 from the second image P20 by moving a pixel area, which is for selecting the wide-area referenced block BR1 to be compared to the wide-area reference block B11, by a predetermined amount (i.e., a first referenced amount of movement) in the second image P20. The wide-area referenced block BR1 is a pixel block that is a candidate for the wide-area corresponding block B21 corresponding to the wide-area reference block B11. The shape and size of the wide-area referenced block BR1 is the same as those of the wide-area reference block B11.

The first search unit 411 derives the similarity between the wide-area referenced block BR1 sequentially selected from the second image P20 and the wide-area reference block B11. The first search unit 411 then determines the “wide-area referenced block BR1 which has the maximum similarity with the wide-area reference block B11” among the wide-area referenced blocks BR1 sequentially selected from the second image P20, as the wide-area corresponding block B21 corresponding to the wide-area reference block B11.

For derivation of this similarity, known similarity derivation processing (similarity calculation method) can be employed. Examples of the method of calculating the similarity include, for example, zero-means normalized cross-correlation (ZNCC), normalized cross-correlation (NCC), the sum of squared difference (SSD), and the sum of absolute difference (SAD).

As described above, the first search processing on the first image P10 and the second image P20 provides a plurality of combinations (hereinafter referred to as “combinations of the wide-area blocks”) of the wide-area reference blocks B11 and the wide-area corresponding blocks B21.

In this example, the first search unit 411 sequentially selects the wide-area referenced block BR1 in a search region R20 extending in a direction (lateral direction in this example) corresponding to the “direction in which the first imaging unit 10 and the second imaging unit 20 are apart from each other (X-axis direction),” using the same position in the second image P20 as the “position of the wide-area reference block B11 in the first image P10” as a starting point. The extending direction of the search region R20 is set to be the direction in which the pixel block at the starting point shifts from the starting point due to the parallax.

The starting point of the search region R20 is not limited to the same position (i.e., the reference position) in the second image P20 as the “position of the wide-area reference block B11 in the first image P10.” For example, the starting point of the search region R20 may be set to be a position in the second image P20 shifted by a predetermined amount (e.g., several blocks) to the right (shifting direction due to the parallax) from the reference position.

### <<Second Search Unit (Second Search Processing)>>

The second search unit 412 performs second search processing. In the second search processing, the second search unit 412 sequentially selects a narrow-area reference block B12 from the wide-area reference block B11, and searches the wide-area corresponding block B21 corresponding to the wide-area reference block B11 for a narrow-area corresponding block B22 corresponding to the narrow-area reference block B12. Specifically, the second search unit 412 performs the following processing in the second search processing.

The second search unit 412 performs the following processing on each of the wide-area reference blocks B11 sequentially selected from the first image P10 by the first search unit 411, and on the wide-area corresponding block B21 corresponding to the wide-area reference block B11.

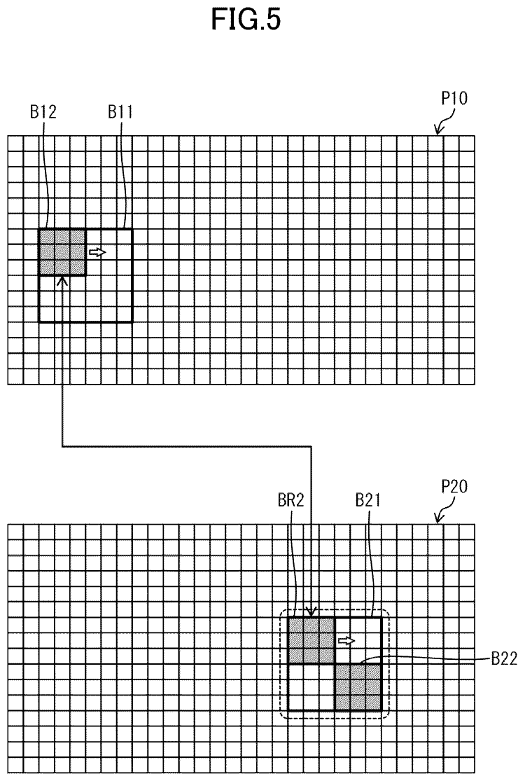

As shown in FIG. 5, the second search unit 412 sequentially selects the narrow-area reference block B12 from the wide-area reference block B11 by moving a pixel area, which is for selecting the narrow-area reference block B12, by a predetermined amount (i.e., a second reference amount of movement) in the wide-area reference block B11. The narrow-area reference block B12 is a pixel block serving as a reference point in searching for a corresponding point in the second search processing. The narrow-area reference block B12 is smaller than the wide-area reference block B11. In the example of FIG. 5, the narrow-area reference block B12 includes nine pixels in a matrix of three rows and three columns. The second search unit 412 then performs the following processing on each of the narrow-area reference blocks B12 sequentially selected from the wide-area reference block B11.

The second search unit 412 sequentially selects a narrow-area referenced block BR2 from the wide-area corresponding block B21 by moving a pixel area, which is for selecting the narrow-area referenced block BR2 to be compared to the narrow-area reference block B12, by a predetermined amount (i.e., a second referenced amount of movement) in the wide-area corresponding block B21 corresponding to the wide-area reference block B11. The narrow-area referenced block BR2 is a pixel block which is a candidate for the narrow-area corresponding block B22 corresponding to the narrow-area reference block B12.

The second search unit 412 derives the similarity between the narrow-area referenced block BR2 sequentially selected from the wide-area corresponding block B21 and the narrow-area reference block B12. The second search unit 412 then determines the “narrow-area referenced block BR2 which has the maximum similarity with the narrow-area reference block B12” among the narrow-area referenced blocks BR2 sequentially selected from the wide-area corresponding block B21, as the narrow-area corresponding block B22 corresponding to the narrow-area reference block B12.

As described above, the second search processing on each of the plurality of the combinations of the wide-area blocks (i.e., the combinations of the wide-area reference blocks B11 and the wide-area corresponding blocks B21) provides a plurality of combinations of the narrow-area reference blocks B12 and the narrow-area corresponding blocks B22 (hereinafter referred to as “combinations of the narrow-area blocks”).

### <<Distance Derivation Unit (Distance Derivation Processing)>>

The distance derivation unit 413 performs distance derivation processing. In the distance derivation processing, the distance derivation unit 413 derives the distance to the surface to be measured in relation to the narrow-area reference block B12, based on the parallax between the narrow-area reference block B12 and the narrow-area corresponding block B22. Specifically, the distance derivation unit 413 performs the following processing in the distance derivation processing.

The distance derivation unit 413 performs the following processing on each of the narrow-area reference blocks B12 sequentially selected from the first image P10 by the second search unit 412.

The distance derivation unit 413 selects the narrow-area corresponding block B22 corresponding to the narrow-area reference block B12 (i.e., the narrow-area corresponding block B22 detected by the second search unit 412) from the second image P20, and derives the difference (i.e., the pixel shift amount) between the positions of the narrow-area reference block B12 and the narrow-area corresponding block B22.

The distance derivation unit 413 then derives the distance D0 (the distance D0 to the surface to be measured) in the narrow-area reference block B12 based on the derived difference in position. Specifically, the distance derivation unit 413 derives the distance D0 to the surface to be measured by the triangulation based on the derived difference in position (i.e., the pixel shift amount), the distance between the first imaging unit 10 and the second imaging unit 20, and the focal length of the first imaging lens 11. The second imaging lens 21 has the same focal length as the first imaging lens 11.

It is possible to obtain, by the processing described above, the distance D0 (the distance D0 to the surface to be measured) in each of the narrow-area reference blocks B12 sequentially selected from the first image P10 by the second search unit 412. The distance derivation unit 413 outputs distance information indicating the distance D0 in each of the narrow-area reference blocks B12 sequentially selected from the first image P10. For example, the distance derivation unit 413 transmits the distance information to an external device via the communication interface 42.

### <<Search Accuracy>>

In this example, the first search unit 411 has a lower search accuracy than the second search unit 412.

Specifically, the first reference amount of movement, which is the amount of movement of the pixel area for selecting the wide-area reference block B11, is larger than the second reference amount of movement, which is the amount of movement of the pixel area for selecting the narrow-area reference block B12. Specifically, the first reference amount of movement is set to n pixels, where n is an integer of two or more, and the second reference amount of movement is set to m pixels, where m is an integer of one or more and is smaller than n. The second reference amount of movement is preferably one pixel.

The first referenced amount of movement, which is the amount of movement of the pixel area for selecting the wide-area referenced block BR1, is larger than the second referenced amount of movement, which is the amount of movement of the pixel area for selecting the narrow-area referenced block BR2. Specifically, the first referenced amount of movement is set to j pixels, where j is an integer of two or more, and the second referenced amount of movement is set to k pixels, where k is an integer of one or more and is smaller than j. The second referenced amount of movement is preferably one pixel.

### [Pattern Light]

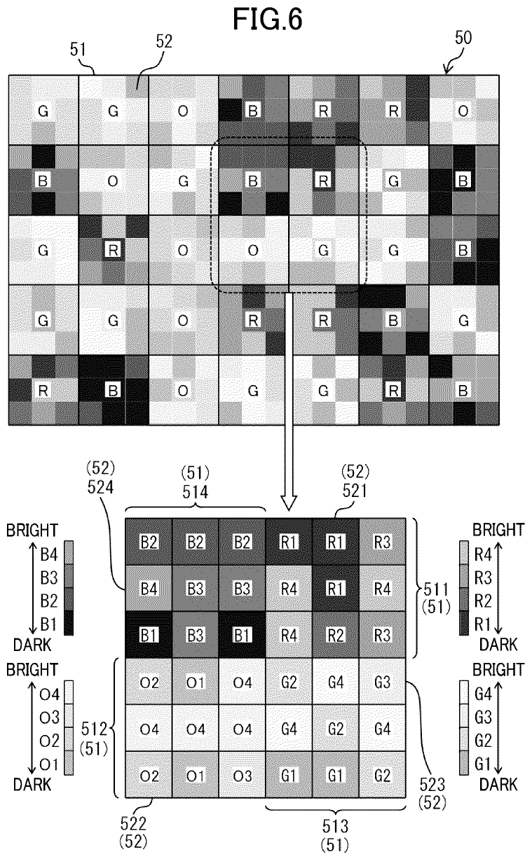

Next, the pattern light 50 will be described with reference to FIG. 6. FIG. 6 illustrates the pattern light 50 projected onto the surface to be measured.

### <Wide-Area Light Region>

The pattern light 50 includes a plurality of wide-area light regions 51. In the example of FIG. 6, the plurality of wide-area light regions 51 are arranged in a matrix. Specifically, the pattern light 50 includes 35 wide-area light regions 51 arranged in a matrix of five rows and seven columns.

The plurality of wide-area light regions 51 are classified into a plurality of types in accordance with hues. In other words, the plurality of wide-area light regions 51 include a plurality of (two or more) wide-area light regions 51 with different hues. In the pattern light 50, the wide-area light regions 51 of the plurality of types (i.e., the plurality of wide-area light regions 51 with different hues) are distributed in a predetermined hue pattern. In this example, the hue pattern is a random pattern.

In the example of FIG. 6, the plurality of wide-area light regions 51 are classified into four types of wide-area light regions 51 (specifically, first to fourth wide-area light regions 511 to 514). The first to fourth wide-area light regions 511 to 514 have different hues (in other words, different wavelength ranges of light).

The hue of the first wide-area light region 511 is “red.” The hue of the second wide-area light region 512 is “orange.” The hue of the third wide-area light region 513 is “green.” The hue of the fourth wide-area light region 514 is “blue.” In other words, light in the first wide-area light region 511 has a wavelength range corresponding to red (e.g., 640 nm to 770 nm). Light in the second wide-area light region 512 has a wavelength range corresponding to orange (e.g., 590 nm to 640 nm). Light in the third wide-area light region 513 has a wavelength range corresponding to green (e.g., 490 nm to 550 nm). Light in the fourth wide-area light region 514 has a wavelength range corresponding to blue (e.g., 430 nm to 490 nm).

In the example of FIG. 6, letters (R, O, G, and B) indicating hues are given to the respective wide-area light regions 51. The letter “R” indicates red; “O” indicates orange; “G” indicates green; and “B” indicates blue. For example, the hue of the wide-area light region 51 given the letter “R” is “red.”

### Narrow-Area Light Region

Each of the plurality of wide-area light regions 51 includes a plurality of narrow-area light regions 52. In the example of FIG. 6, the plurality of narrow-area light regions 52 are arranged in a matrix. Specifically, each of the 35 wide-area light regions 51 includes nine narrow-area light regions 52 arranged in a matrix of three rows and three columns.

The plurality of narrow-area light regions 52 are classified into a plurality of types in accordance with hues and levels of luminance. In other words, the plurality of narrow-area light regions 52 included in each of the plurality of wide-area light regions 51 include a plurality of (two or more) narrow-area light regions 52 with the same hue but with different levels of luminance. In each of the plurality of wide-area light regions 51, the narrow-area light regions 52 of the plurality of types (i.e., the plurality of narrow-area light regions 52 with the same hue but with different levels of luminance) are distributed in a predetermined luminance pattern. In this example, the luminance pattern is a random pattern.

In the example of FIG. 6, the plurality of narrow-area light regions 52 included in each of the plurality of wide-area light regions 51 are classified into four types of narrow-area light regions 52 (specifically, first to fourth narrow-area light regions 521 to 524). The first to fourth narrow-area light regions 521 to 524 have different levels of luminance.

The luminance of the first narrow-area light region 521 is “level 1.” The luminance of the second narrow-area light region 522 is “level 2.” The luminance of the third narrow-area light region 523 is “level 3.” The luminance of the fourth narrow-area light region 524 is “level 4.” The luminance gradually increases in the order from “level 1” to “level 4” of the luminance.

In the example of FIG. 6, a letter (R, O, G, or B) indicating the hue and the number (1,2, 3, or 4) indicating the level of luminance are given to each narrow-area light region 52. For example, the narrow-area light region 52 given “R1” has the hue of “red” and the luminance of “level 1.”

### [Relationship Between Pattern Light and Image]

The pattern light 50 is projected onto the surface to be measured (i.e., the surface of the object OB in this example). The first imaging unit 10 performs imaging of the range of the first visual field 10a including the surface to be measured onto which the pattern light 50 is projected, thereby making it possible to obtain the first image P10 including the pattern light 50 projected onto the surface to be measured. Together with (simultaneously with) the imaging by the first imaging unit 10, the second imaging unit 20 performs imaging, thereby making it possible to obtain the second image P20 including the pattern light 50 projected onto the surface to be measured.

In this example, if the distance D0 to the surface to be measured is a reference distance (e.g., an intermediate distance of the distance measurement range), the shape of each narrow-area light region 52 (i.e., dotted light) in the pattern light 50 included in the first image P10 is the shape corresponding to the shape of one pixel of the first image P10 (e.g., the same shape as one pixel). The distance measurement range is a range of distance measurable by the distance measurement device 1. The size of each narrow-area light region 52 (dotted light) is the size corresponding to the size of one pixel of the first image P10 (e.g., the same size as one pixel).

The shape and size of each narrow-area light region 52 in the first image P10 are not limited to those described above. For example, each narrow-area light region 52 in the first image P10 may be in a shape different from the shape (i.e., the rectangle) of one pixel of the first image P10. Each narrow-area light region 52 in the first image P10 may be in a size corresponding to the size of two or more (preferably, two to four) pixels of the first image P10. In other words, in the first image P10, one narrow-area light region 52 may be included in two or more pixels of the first image P10. Alternatively, each narrow-area light region 52 in the first image P10 may be smaller in size than one pixel of the first image P10.

In this example, if the distance D0 to the surface to be measured is a reference distance, the shape of each wide-area light region 51 (an aggregate of dotted light) in the pattern light included in the first image P10 is the shape corresponding to the shape of the narrow-area reference block B12 (e.g., the same shape as the narrow-area reference block B12). The size of each wide-area light region 51 (an aggregate of dotted light) is the size corresponding to the size of the narrow-area reference block B12 (e.g., the same size as the narrow-area reference block B12).

The shape and size of each wide-area light region 51 in the first image P10 are not limited to those described above. For example, each wide-area light region 51 in the first image P10 may be in a shape different from the shape (i.e., the rectangle) of the narrow-area reference block B12. The wide-area light region 51 in the first image P10 may be larger in size than the narrow-area reference block B12 or may be smaller in size than the narrow-area reference block B12.

In this example, the hue pattern (i.e., the distribution pattern of the wide-area light regions 51 of the plurality of types) in the pattern light 50 included in the first image P10 is set such that under the condition that the distance D0 to the surface to be measured is a reference distance, the wide-area light regions 51 of the plurality of types (the plurality of wide-area light regions 51 with different hues) are included in each of the wide-area reference blocks B11 sequentially selected from the first image P10 in the first search processing.

The hue pattern of the pattern light 50 included in the first image P10 is preferably set such that under the conditions described above, the distribution patterns of the wide-area light regions 51 of the plurality of types included in each of the wide-area reference blocks B11 sequentially selected from the first image P10 in the first search processing differ from each other.

In this example, the luminance pattern (i.e., the distribution pattern of the narrow-area light regions 52 of the plurality of types) in each of the plurality of wide-area light regions 51 included in the first image P10 is set such that under the condition that the distance D0 to the surface to be measured is a reference distance, the narrow-area light regions 52 of plurality of types (i.e., the plurality of narrow-area light regions 52 with the same hue but with different levels of luminance) are included in each of the narrow-area reference blocks B12 sequentially selected from the wide-area reference block B11 in the second search processing.

The luminance pattern of each of the plurality of wide-area light regions 51 included in the first image P10 is preferably set such that under the conditions described above, the distribution patterns of the narrow-area light regions 52 of the plurality of types included in each of the narrow-area reference blocks B12 sequentially selected from the wide-area reference block B11 in the second search processing differ from each other.

### [Filter]

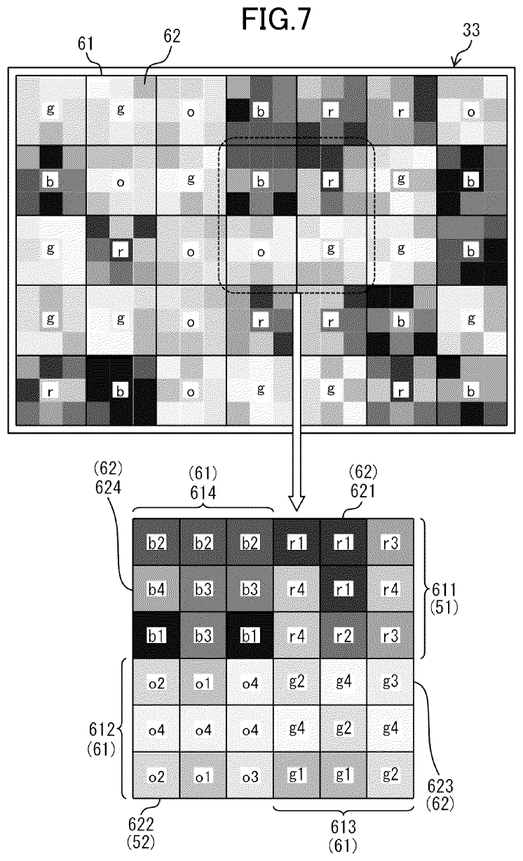

Next, a configuration of the filter 33 will be described with reference to FIG. 7. FIG. 7 is a diagram of the filter 33 as an example, viewed from a light incident surface. In this example, the filter 33 is a transmissive filter.

### <Wide-Area Filter Region>

The filter 33 includes a plurality of wide-area filter regions 61. The plurality of wide-area filter regions 61 respectively correspond to the plurality of wide-area light regions 51, and each wide-area filter region 61 generates a corresponding wide-area light region 51. In the example of FIG. 7, the plurality of wide-area filter regions 61 are arranged in a matrix. Specifically, the filter 33 includes 35 wide-area filter regions 61 in a matrix of five rows and seven columns.

The plurality of wide-area filter regions 61 are classified into a plurality of types in accordance with the hues of the wide-area light regions 51 to be generated. In other words, the plurality of wide-area filter regions 61 include a plurality of (two or more) wide-area filter regions 61 generating the wide-area light regions 51 with different hues.

The wide-area filter regions 61 of the plurality of types (the plurality of wide-area filter regions 61 generating the wide-area light regions 51 with different hues) respectively correspond to the wide-area light regions 51 of the plurality of types in the pattern light 50, and are distributed in the same pattern as the hue pattern.

Each of the plurality of wide-area filter regions 61 extracts light in a wavelength range corresponding to the hue of the wide-area light region 51 corresponding to the wide-area filter region 61, from the light emitted from the light source 31.

In this example, each of the plurality of wide-area filter regions 61 transmits, of the light emitted from the light source 31, light in a wavelength range corresponding to the hue of the wide-area light region 51 corresponding to the wide-area filter region 61. Specifically, the transmitting wavelength range of (i.e., the wavelength range of light that can be transmitted through) each of the plurality of wide-area filter regions 61 is set to a wavelength range that corresponds to the hue of the wide-area light region 51 corresponding to the wide-area filter region 61. Each of the plurality of wide-area filter regions 61 has a high transmittance with respect to light in the transmitting wavelength range (i.e., the wavelength range corresponding to the hue of the wide-area light region 51 corresponding to the wide-area filter region 61) and has a low transmittance with respect to light in the other wavelength ranges.

In the example of FIG. 7, the plurality of wide-area filter regions 61 are classified into four types of wide-area filter regions 61 (specifically, first to fourth wide-area filter regions 611 to 614) respectively corresponding to the four types of wide-area light regions 51. The first to fourth wide-area filter regions 611 to 614 have different transmitting wavelength ranges.

The transmitting wavelength range of the first wide-area filter region 611 is set to the wavelength range that corresponds to “red,” which is the hue of the first wide-area light region 511. The transmitting wavelength range of the second wide-area filter region 612 is set to the wavelength range that corresponds to “orange,” which is the hue of the second wide-area light region 512. The transmitting wavelength range of the third wide-area filter region 613 is set to the wavelength range that corresponds to “green,” which is the hue of the third wide-area light region 513. The transmitting wavelength range of the fourth wide-area filter region 614 is set to the wavelength range that corresponds to “blue,” which is the hue of the fourth wide-area light region 514.

In the example of FIG. 7, each of the wide-area filter regions 61 is given a letter (r, o, g, or b) indicating the hue corresponding to the transmitting wavelength range of the respective wide-area filter region 61. The letter “r” indicates that the transmitting wavelength range is the wavelength range corresponding to “red.” The letter “o” indicates that the transmitting wavelength range is the wavelength range corresponding to “orange.” The letter “g” indicates that the transmitting wavelength range is the wavelength range corresponding to “green.” The letter “b” indicates that the transmitting wavelength range is the wavelength range corresponding to “blue.” For example, the wide-area filter region 61 given the letter “r” is a region where the transmitting wavelength range is set to a wavelength range corresponding to “red.”

### <Narrow-Area Filter Region>

Each of the plurality of wide-area filter regions 61 includes a plurality of narrow-area filter regions 62. The plurality of narrow-area filter regions 62 respectively correspond to the plurality of narrow-area light regions 52, and each narrow-area filter region 62 generates a corresponding narrow-area light region 52. In the example of FIG. 7, the plurality of narrow-area filter regions 62 are arranged in a matrix. Specifically, each of 35 wide-area filter regions 61 includes nine narrow-area filter regions 62 arranged in a matrix of three rows and three columns.

The plurality of narrow-area filter regions 62 included in each of the plurality of wide-area filter regions 61 are classified into a plurality of types in accordance with the levels of luminance of the narrow-area light regions 52 to be generated. In other words, the plurality of narrow-area filter regions 62 included in each of the plurality of wide-area filter regions 61 include a plurality of (two or more) narrow-area filter regions 62 generating the narrow-area light regions 52 with the same hue but with different levels of luminance.

In each of the plurality of wide-area filter regions 61, the narrow-area filter regions 62 of the plurality of types (the plurality of narrow-area filter regions 62 generating the narrow-area light regions 52 with the same hue but with different levels of luminance) respectively correspond to the narrow-area light regions 52 of the plurality of types included in the wide-area light region 51 corresponding to the wide-area filter region 61. The narrow-area filter regions 62 are distributed in the same pattern as the luminance pattern in the wide-area light region 51.

Each of the plurality of narrow-area filter regions 62 extracts, from the light emitted from the light source 31, light in a wavelength range corresponding to the hue of the wide-area light region 51 that corresponds to the wide-area filter region 61 including the narrow-area filter region 62, by an amount corresponding to the luminance of the narrow-area light region 52 that corresponds to the narrow-area filter region 62.

In this example, each of the plurality of narrow-area filter regions 62 transmits, of the light emitted from the light source 31, light in a wavelength range corresponding to the hue of the wide-area light region 51 that corresponds to the wide-area filter region 61 including the narrow-area filter region 62, at a transmittance corresponding to the luminance of the narrow-area light region 52 that corresponds to the narrow-area filter region 62.

Specifically, the transmitting wavelength range of each of the plurality of narrow-area filter regions 62 is set to a wavelength range that corresponds to the hue of the wide-area light region 51 corresponding to the wide-area filter region 61 including the narrow-area filter region 62. The transmittance of light in the transmitting wavelength range in each of the plurality of narrow-area filter regions 62 is set to a transmittance that corresponds to the luminance of the narrow-area light region 52 corresponding to the narrow-area filter region 62. The higher the luminance of the narrow-area light region 52, the higher the transmittance of light in the transmitting wavelength range of the narrow-area filter region 62. The transmittance of light in the wavelength range other than the transmitting wavelength range of each of the plurality of narrow-area filter regions 62 is lower than the transmittance of light in the transmitting wavelength range.

In the example of FIG. 7, the plurality of narrow-area filter regions 62 included in each of the plurality of wide-area filter regions 61 are classified into four types of narrow-area filter regions 62 (specifically, first to fourth narrow-area filter regions 621 to 624) respectively corresponding to the four types of narrow-area light regions 52. The level of transmittance with respect to light in the transmitting wavelength range differs among the first to fourth narrow-area filter regions 621 to 624.

The level of transmittance of light in the transmitting wavelength range of the first narrow-area filter region 621 is set to “level 1” corresponding to the level (level 1) of the luminance of the first narrow-area light region 521 corresponding to the first narrow-area filter region 621. The level of transmittance of light in the transmitting wavelength range of the second narrow-area filter region 622 is set to “level 2” corresponding to the level (level 2) of the luminance of the second narrow-area light region 522 corresponding to the second narrow-area filter region 622. The level of transmittance of light in the transmitting wavelength range of the third narrow-area filter region 623 is set to “level 3” corresponding to the level (level 3) of the luminance of the third narrow-area light region 523 corresponding to the third narrow-area filter region 623. The level of transmittance of light in the transmitting wavelength range of the fourth narrow-area filter region 624 is set to “level 4” corresponding to the level (level 4) of the luminance of the fourth narrow-area light region 524 corresponding to the fourth narrow-area filter region 624. The transmittance gradually increases in the order from “level 1” to “level 4” of the transmittance.

In the example of FIG. 7, each of the narrow-area filter regions 62 is given a letter (r, o, g, or b) indicating the hue corresponding to the transmitting wavelength range of the narrow-area filter region 62 and a number (1, 2, 3, or 4) indicating a level of transmittance of light in the transmitting wavelength range. For example, the narrow-area filter region 62 given “r1” is a region where the transmitting wavelength range is set to a wavelength range corresponding to “red” and the transmittance of light in the transmitting wavelength range is set to “level 1.”

### <Output Characteristics of Light Source>

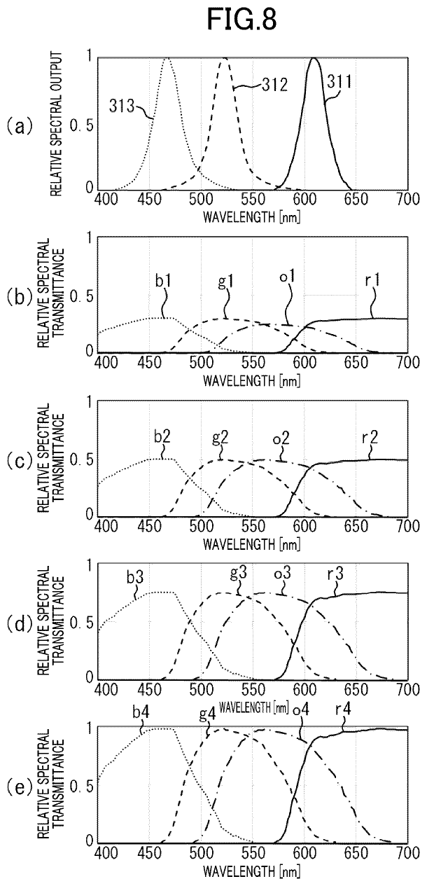

In FIG. 8, (a) is a graph illustrating as an example an output (a spectral output) of each of the first light source 311, the second light source 312, and the third light source 313. The first light source 311 emits light with a center wavelength around 610 nm and an emission bandwidth of about 80 nm. The second light source 312 emits light with a center wavelength around 520 nm and an emission bandwidth of about 150 nm. The third light source 313 emits light with a center wavelength around 470 nm and an emission bandwidth of about 100 nm.

As shown in (a) of FIG. 8, in this example, the maximum output of each of the first to third light sources 311 to 313 can be regarded as being the same.

### <Transmittance Characteristics of Narrow-Area Filter Region>

In FIG. 8, (b) is a graph illustrating as an example the transmittance characteristics of the first narrow-area filter region 621. In (b) of FIG. 8, the characters “r1” indicate the transmittance characteristics of the first narrow-area filter region 621 whose transmitting wavelength range is set to the wavelength range corresponding to “red.” The characters “o1” indicate the transmittance characteristics of the first narrow-area filter region 621 whose transmitting wavelength range is set to the wavelength range corresponding to “orange.” The characters “g1” indicate the transmittance characteristics of the first narrow-area filter region 621 whose transmitting wavelength range is set to the wavelength range corresponding to “green.” The characters “b1” indicate the transmittance characteristics of the first narrow-area filter region 621 whose transmitting wavelength range is set to the wavelength range corresponding to “blue.”

As shown in (b) of FIG. 8, in this example, the transmittance of light (i.e., the transmittance of light in the transmitting wavelength range) of the first narrow-area filter region 621 is set to level 1 (about 0.3 times the maximum transmittance in the example of (b) of FIG. 8) in any hue. Accordingly, the level of luminance of the first narrow-area light region 521 generated by the first narrow-area filter region 621 is the same level (level 1) in any hue.

In FIG. 8, (c) is a graph illustrating as an example the transmittance characteristics of the second narrow-area filter region 622. In (c) of FIG. 8, the characters “r2” indicate the transmittance characteristics of the second narrow-area filter region 622 whose transmitting wavelength range is set to the wavelength range corresponding to “red.” The characters “o2” indicate the transmittance characteristics of the second narrow-area filter region 622 whose transmitting wavelength range is set to the wavelength range corresponding to “orange.” The characters “g2” indicate the transmittance characteristics of the second narrow-area filter region 622 whose transmitting wavelength range is set to the wavelength range corresponding to “green.” The characters “b2” indicate the transmittance characteristics of the second narrow-area filter region 622 whose transmitting wavelength range is set to the wavelength range corresponding to “blue.”

As shown in (c) of FIG. 8, in this example, the transmittance of light (i.e., the transmittance of light in the transmitting wavelength range) of the second narrow-area filter region 622 is set to level 2 (about 0.5 times the maximum transmittance in the example of (c) of FIG. 8) in any hue. Accordingly, the level of luminance of the second narrow-area light region 522 generated by the second narrow-area filter region 622 is the same level (level 2) in any hue.

In FIG. 8, (d) is a graph illustrating as an example the transmittance characteristics of the third narrow-area filter region 623. In (d) of FIG. 8, the characters “r3” indicate the transmittance characteristics of the third narrow-area filter region 623 whose transmitting wavelength range is set to the wavelength range corresponding to “red.” The characters “o3” indicate the transmittance characteristics of the third narrow-area filter region 623 whose transmitting wavelength range is set to the wavelength range corresponding to “orange.” The characters “g3” indicate the transmittance characteristics of the third narrow-area filter region 623 whose transmitting wavelength range is set to the wavelength range corresponding to “green.” The characters “b3” indicate the transmittance characteristics of the third narrow-area filter region 623 whose transmitting wavelength range is set to the wavelength range corresponding to “blue.”As shown in (d) of FIG. 8, in this example, the transmittance of light (i.e., the transmittance of light in the transmitting wavelength range) of the third narrow-area filter region 623 is set to level 3 (about 0.7 times the maximum transmittance in the example of (d) of FIG. 8) in any hue. Accordingly, the level of luminance of the third narrow-area light region 523 generated by the third narrow-area filter region 623 is the same level (level 3) in any hue.

In FIG. 8, (e) is a graph illustrating as an example the transmittance characteristics of the fourth narrow-area filter region 624. In (e) of FIG. 8, the characters “r4” indicate the transmittance characteristics of the fourth narrow-area filter region 624 whose transmitting wavelength range is set to the wavelength range corresponding to “red.” The characters “o4” indicate the transmittance characteristics of the fourth narrow-area filter region 624 whose transmitting wavelength range is set to the wavelength range corresponding to “orange.” The characters “g4” indicate the transmittance characteristics of the fourth narrow-area filter region 624 whose transmitting wavelength range is set to the wavelength range corresponding to “green.” The characters “b4” indicate the transmittance characteristics of the fourth narrow-area filter region 624 whose transmitting wavelength range is set to the wavelength range corresponding to “blue.”As shown in (e) of FIG. 8, in this example, the transmittance of light (i.e., the transmittance of light in the transmitting wavelength range) of the fourth narrow-area filter region 624 is set to level 4 (about the same level as the maximum transmittance in the example of (e) of FIG. 8) in any hue. Accordingly, the level of luminance of the fourth narrow-area light region 524 generated by the fourth narrow-area filter region 624 is the same level (level 4) in any hue.

### [Luminance Adjustment Processing]

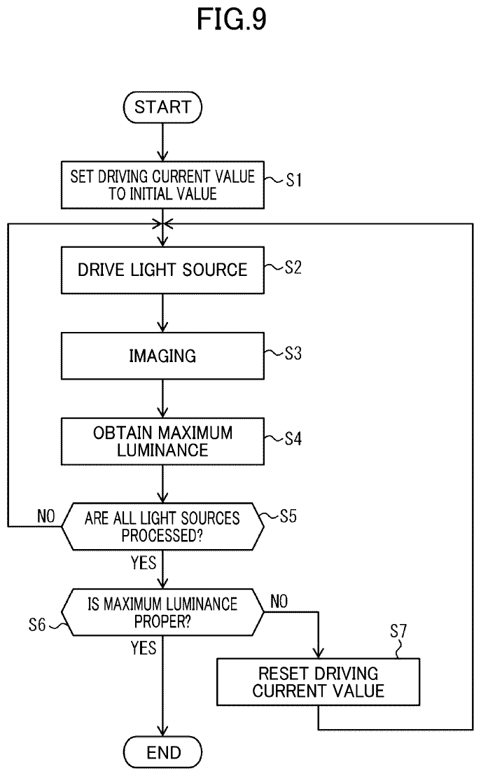

Next, the luminance adjustment processing performed by the projection control unit 403 will be described with reference to FIG. 9. For example, the luminance adjustment processing is performed before the start of the distance measurement processing.

### <Step S1>

The projection control unit 403 sets the driving current value of each of the light sources 31 (specifically, each of the first to third light sources 311 to 313) to an initial value. The initial value of the driving current value is set so that when the reflectance of the surface to be measured is a predetermined value (an assumed standard reflectance), the maximum luminance of the light emitted from the light source 31 properly falls within a “range of gradation (e.g., 0 to 255) that defines the luminance in the controller 40.” For example, the initial value of the driving current value of the light source 31 is set so that the maximum luminance of the light source 31 is slightly smaller than the maximum gradation in the range of gradation described above (e.g., about 80% to 90% the maximum gradation).

### <Step S2>

Next, the projection control unit 403 selects a light source 31 as a target of processing from among the light sources 31 that are not yet processed out of the first to third light sources 311 to 313, and causes the light source driving unit 35 to drive the selected light source 31. The light sources 31 that are not yet processed are the light sources 31 not subjected to the processing of Steps S2 to S4 after Step S1 or Step S7.

Specifically, the projection control unit 403 transmits, to the light source driving unit 35, a command to drive the light source 31 selected as the target of processing, and the driving current value set for the light source 31. The light source driving unit 35 drives the light source 31 selected by the projection control unit 403, based on the driving current value transmitted from the projection control unit 403. Accordingly, light is projected from the light source 31 selected by the projection control unit 403 onto the surface to be measured (i.e., the surface of the object OB in this example).

### <Step S3>

Next, the projection control unit 403 causes the first imaging unit 10 to perform imaging in a state in which the light is projected from the light source 31 selected in Step S2 onto the surface to be measured. Accordingly, the first image P10 is obtained which includes the light projected from the light source 31 onto the surface to be measured.

### <Step S4>

Next, the projection control unit 403 obtains the maximum luminance of the pixel from the first image P10 obtained in Step S3. The maximum luminance of the pixel corresponds to the maximum luminance of the light projected from the light source 31 selected in Step S2 onto the surface to be measured.

### <Step S5>

Next, the projection control unit 403 determines whether there is any light source 31 of the first to third light sources 311 to 313 remaining not yet processed. If there is a light source 31 remaining not yet processed, the processing of Step S2 is performed. Otherwise, the processing of Step S6 is performed.

### <Step S6>

Next, the projection control unit 403 determines whether the maximum luminance of the light emitted from each of the light sources 31 (specifically, each of the first to third light sources 311 to 313) is proper. If the maximum luminance of the light emitted from the light source 31 is proper, the luminance adjustment processing ends. Otherwise, the processing of Step S7 is performed.

In this example, the projection control unit 403 determines whether the balance of the maximum luminance of each of the first to third light sources 311 to 313 is proper. If the maximum luminance of each of the first to third light sources 311 to 313 is considered being the same (e.g., if the differences among the values of the maximum luminance of the first to third light sources 311 to 313 are within an allowable range), the projection control unit 403 determines that the balance of the maximum luminance of each of the first to third light sources 311 to 313 is proper.

In this example, the projection control unit 403 determines whether the maximum luminance of the light emitted from each of the light sources 31 (specifically, each of the first to third light sources 311 to 313) is saturated. Specifically, the projection control unit 403 determines that the maximum luminance of the light source 31 is saturated when the maximum luminance of the light source 31 reaches the “maximum gradation in the range of gradation that defines the luminance in the controller 40.”

### <Step S7>

If the maximum luminance of each of the light sources 31 (specifically, each of the first to third light sources 311 to 313) is improper, the projection control unit 403 resets the driving current value of the light source 31 so that the maximum luminance of the light source 31 is proper. Next, the processing in Step S2 is performed.

For example, in this example, if the balance of the maximum luminance of each of the first to third light sources 311 to 313 is improper, the projection control unit 403 resets the driving current value of each of the first to third light sources 311 to 313 so that the balance of the maximum luminance of each of the first to third light sources 311 to 313 is proper.

Specifically, the projection control unit 403 selects the highest maximum luminance from the maximum luminance of each of the first to third light sources 311 to 313 as the “reference luminance.” Next, the projection control unit 403 selects the “light source 31 whose maximum luminance is lower than the reference luminance” from the first to third light sources 311 to 313, and increases the driving current value set for the selected light source 31.

In addition, in this example, if the maximum luminance of the light emitted from each of the light sources 31 (specifically, each of the first to third light sources 311 to 313) is saturated, the projection control unit 403 resets the driving current value of the light source 31 so that the luminance of the light emitted from the light source 31 is not saturated.

Specifically, the projection control unit 403 decreases the driving current value set for the light source 31 whose maximum luminance is saturated among the first to third light sources 311 to 313. For example, the projection control unit 403 corrects the driving current value set for the light source 31 so that the driving current value is lower by a predetermined gradation than the driving current value derived from the “relationship between the luminance of the light emitted from the light source 31 and the driving current value” and the “maximum gradation in the range of gradation that defines the luminance in the controller 40.”

### [Distance Measurement Processing]

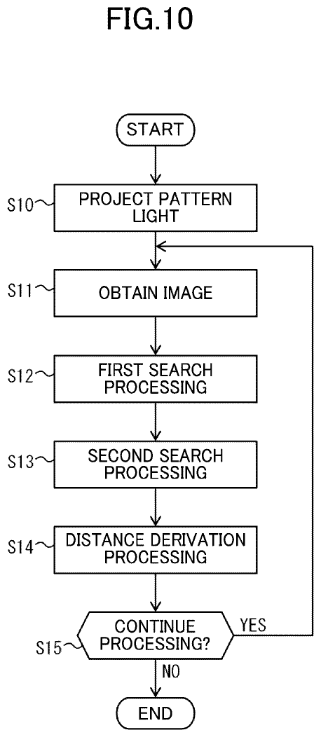

Next, distance measurement processing will be described with reference to FIG. 10. The distance measurement processing is an example of the distance measurement method. For example, the controller 40 performs the following processing when the distance measurement device 1 starts operating.

### <Step S10>

First, the controller 40 (i.e., the projection control unit 403) controls the projection unit 30 so that it projects the pattern light 50 on an area in which the first visual field 10a of the first imaging unit 10 and the second visual field 20a of the second imaging unit 20 overlap each other.

### <Step S11>

Next, the controller 40 obtains the first image P10 obtained by the first imaging unit 10 and the second image P20 obtained by the second imaging unit 20. In this example, the controller 40 selects a first image P10 and a second image P20 as the target of processing from the first images P10 and the second images P20 stored in the storage 41 and obtains the selected first image P10 and second image P20.

### <Step S12>

Next, the controller 40 (i.e., the first search unit 411) performs the first search processing on the first image P10 and the second image P20 obtained in Step S11, thereby obtaining a plurality of combinations of the wide-area blocks (e.g., combinations of the wide-area reference blocks B11 and the wide-area corresponding blocks B21).

### <Step S13>

Next, the controller 40 (i.e., the second search unit 412) performs the second search processing on the combinations of the wide-area blocks (i.e., the combinations of the wide-area reference blocks B11 and the wide-area corresponding blocks B21) obtained in Step S12. Accordingly, a plurality of combinations of the narrow-area blocks (e.g., combinations of the narrow-area reference blocks B12 and the narrow-area corresponding blocks B22) are obtained.

### <Step S14>

Next, the controller 40 (i.e., the distance derivation unit 413) performs the distance derivation processing based on the combinations of the narrow-area blocks (e.g., the combinations of the narrow-area reference blocks B12 and the narrow-area corresponding blocks B22) obtained in Step S13. Accordingly, the distance information (i.e., the distance information indicating the distance D0 of each of the narrow-area reference blocks B12 sequentially selected from the first image P10) is obtained.

### <Step S15>

Next, the controller 40 determines whether to continue the distance measurement processing. To continue the distance measurement processing, the processing in Step S11 is performed. Otherwise, the distance measurement processing ends.

### [Advantages of Embodiment]

As described above, according to the distance measurement device 1 of the embodiment, the projection unit 30 projects the pattern light 50 on an area where the first visual field 10a of the first imaging unit 10 and the second visual field 20a of the second imaging unit 20 overlap each other. The pattern light 50 is pattern light which includes a plurality of wide-area light regions 51 with different hues distributed in a predetermined hue pattern, and the plurality of narrow-area light regions 52 with the same hue but with different levels of luminance distributed in a predetermined luminance pattern in each of the plurality of wide-area light regions 51.

In other words, the pattern light 50 is pattern light which includes a plurality of light regions with different hues and a plurality of light regions with the same hue and different levels of luminance, and in which a plurality of wide-area light regions 51 are distributed in a predetermined pattern and a plurality of narrow-area light regions 52 are distributed in another predetermined pattern in each of the plurality of wide-area light regions 51. The plurality of wide-area light regions 51 include a plurality of light regions with different hues and are distributed in a predetermined hue pattern. The plurality of narrow-area light regions 52 include a plurality of light regions with the same hue and different levels of luminance and are distributed in a predetermined luminance pattern.

According to the configuration described above, it is possible to form a unique pattern (texture) on a surface to be measured, by projecting unique pattern light 50 onto the surface to be measured. It is thus possible to perform stereo matching (search for a corresponding point) even if the surface to be measured includes a plain surface (e.g., a flat monochromatic surface). This enables accurate measurement of the distance D0 to the surface to be measured.

Depending on the surface to be measured, the light absorptance may be high or the light reflectance may be low in a specific wavelength range. Thus, if the pattern light 50 is formed of light in a single wavelength range, and the wavelength range of the pattern light 50 is included in the specific wavelength range, it is difficult to form a unique pattern on the surface to be measured.

On the other hand, according to the distance measurement device 1 of the embodiment, the pattern light 50 includes the plurality of wide-area light regions 51 with different hues (wavelength ranges) distributed in a predetermined hue pattern. Accordingly, even if the wavelength range corresponding to the hue of any of the plurality of wide-area light regions 51 is included in the above specific wavelength range (i.e., the wavelength range in which the light absorptance increases or the light reflectance decreases), the remaining wide-area light regions 51 are projected onto the surface to be measured (i.e., the surface of the object OB in this example), thereby making it possible to form a unique pattern on the surface to be measured.

According to the distance measurement device 1 of the embodiment, the projection unit 30 includes the filter 33 for generating the pattern light 50. The filter 33 includes a plurality of wide-area filter regions 61 distributed in the same pattern as the hue pattern so as to correspond respectively to the plurality of wide-area light regions 51. Each of the plurality of wide-area filter regions 61 includes a plurality of narrow-area filter regions 62 distributed in the same pattern as the luminance pattern so as to correspond respectively to the plurality of narrow-area light regions 52 included in the wide-area light region 51 which corresponds to the wide-area filter region 61, out of the plurality of wide-area light regions 51.

In other words, the filter 33 includes a plurality of wide-area filter regions 61 including a plurality of filter regions for generating the plurality of light regions with different hues and a plurality of filter regions for generating the plurality of light regions with the same hue and different levels of luminance; and the plurality of wide-area filter regions 61 are distributed in the same pattern as the predetermined pattern (i.e., the predetermined pattern of the wide-area light regions 51) so as to correspond respectively to the plurality of wide-area light regions 51. Each of the plurality of wide-area filter regions 61 includes a plurality of narrow-area filter regions 62 distributed in the same pattern as the predetermined pattern (i.e., the predetermined pattern of the narrow-area light regions 52) so as to correspond respectively to the plurality of narrow-area light regions 52 included in the wide-area light region 51 which corresponds to the wide-area filter region 61, out of the plurality of wide-area light regions 51.

According to the configuration described above, it is possible to generate the pattern light 50 having a desired pattern easily. Moreover, unlike a diffractive optical element, no variation in diffraction efficiency (or no variation in luminance gradation) due to a manufacturing error or an assembly error occurs, which makes it possible to generate the pattern light 50 having a desired pattern stably.

According to the distance measurement device 1 of the embodiment, the projection unit 30 includes: the light source 31; and the optical system 32 configured to guide the light emitted from the light source 31 to the filter 33. According to this configuration, it is possible to make the filter 33 irradiated with light for generating the pattern light 50 easily.

According to the distance measurement device 1 of the embodiment, each of the plurality of wide-area filter regions 61 transmits, of the light emitted from the light source 31, light in a wavelength range corresponding to the hue of the wide-area light region 51 corresponding to the wide-area filter region 61. Each of the plurality of narrow-area filter regions 62 transmits, of the light emitted from the light source 31, light in a wavelength range corresponding to the hue of the wide-area light region 51 that corresponds to the wide-area filter region 61 including the narrow-area filter region 62, at a transmittance corresponding to the luminance of the narrow-area light region 52 that corresponds to the narrow-area filter region 62.

In other words, in the filter 33, each of the plurality of filter regions for generating the plurality of light regions with different hues extracts light in a wavelength range corresponding to the plurality of light regions with different hues from the light emitted from the light source 31. Each of the plurality of filter regions for generating the plurality of light regions with the same hue and different levels of luminance extracts, from the light emitted from the light source 31, light in a wavelength range corresponding to the plurality of light regions with the same hue and different levels of luminance by an amount corresponding to the luminance.

According to the configuration described above, it is possible for each of the plurality of wide-area filter regions 61 to selectively extract light in a wavelength range corresponding to the hue of the wide-area light region 51 corresponding to the wide-area filter region 61. It is possible for each of the plurality of narrow-area filter regions 62 to selectively extract light in a wavelength range corresponding to the hue of the wide-area light region 51 that corresponds to the wide-area filter region 61 including the narrow-area filter region 62, by an amount corresponding to the luminance of the narrow-area light region 52 that corresponds to the narrow-area filter region 62. This enables efficient generation of the pattern light 50.

According to the distance measurement device 1 of the embodiment, the projection control unit 403 adjusts the luminance of the light emitted from the light source 31 so that the luminance of the light emitted from the light source 31 is not saturated. According to this configuration, it is possible to set the luminance of the light emitted from the light source 31 properly.

According to the distance measurement device 1 of the embodiment, the first search unit 411 sequentially selects a wide-area reference block B11 from the first image P10 and searches the second image P20 for a wide-area corresponding block B21 corresponding to the wide-area reference block B11. The second search unit 412 sequentially selects a narrow-area reference block B12 from the wide-area reference block B11 and searches a wide-area corresponding block B21 corresponding to the wide-area reference block B11 for a narrow-area corresponding block B22 corresponding to the narrow-area reference block B12. The distance derivation unit 413 derives the distance D0 to the surface to be measured in relation to the narrow-area reference block B12, based on the difference in position between the narrow-area reference block B12 and the narrow-area corresponding block B22.

According to the configuration described above, it is possible to perform search (relatively fine search) by the second search unit 412 on a pixel block detected by search (relatively rough search) by the first search unit 411. It is thus possible to shorten the time required for search for a corresponding point (specifically, search for the narrow-area corresponding block B22) as compared to a case in which only the search by the second search unit 412 is performed (specifically, a case in which a narrow-area reference block B12 is sequentially selected from the first image P10, and a search for a narrow-area corresponding block B22 corresponding to the narrow-area reference block B12 is conducted in the second image P20). It is thus possible to increase the speed in measuring the distance D0 by the distance measurement device 1.

According to the distance measurement device 1 of the embodiment, the first reference amount of movement, which is the amount of movement of the pixel area for selecting the wide-area reference block B11, is larger than the second reference amount of movement, which is the amount of movement of the pixel area for selecting the narrow-area reference block B12. According to this configuration, it is possible to shorten the time required for selecting the wide-area reference block B11 and thus increase the speed of the first search processing (i.e., search by the first search unit 411). It is thus possible to increase the speed in measuring the distance D0 by the distance measurement device 1.

According to the distance measurement device 1 of the embodiment, the first referenced amount of movement, which is the amount of movement of the pixel area for selecting the wide-area referenced block BR1, is larger than the second referenced amount of movement, which is the amount of movement of the pixel area for selecting the narrow-area referenced block BR2. According to this configuration, it is possible to shorten the time required for selecting the wide-area referenced block BR1 and thus increase the speed of the first search processing (i.e., search by the first search unit 411). It is thus possible to increase the speed in measuring the distance D0 by the distance measurement device 1.

### First Variation of Embodiment

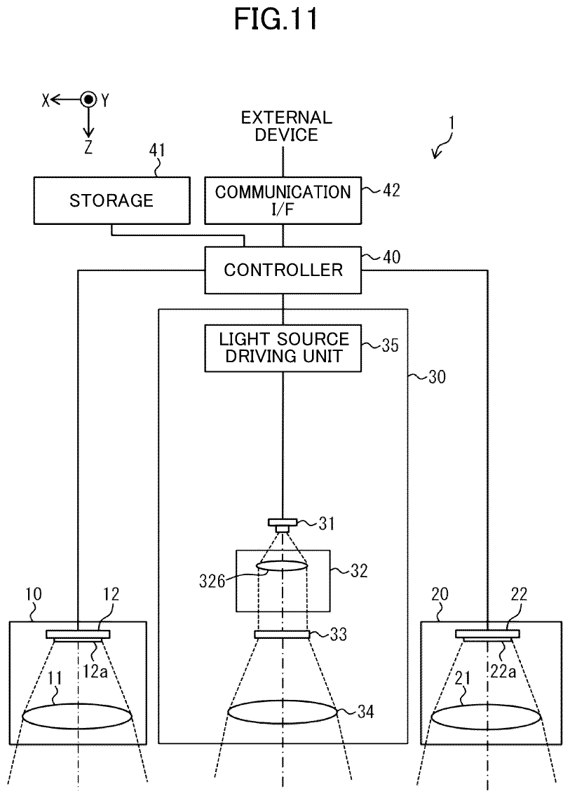

FIG. 11 illustrates as an example a configuration of a distance measurement device 1 according to a first variation of the embodiment. The distance measurement device 1 according to the first variation of the embodiment differs from the distance measurement device 1 according to the embodiment in the configuration of the projection unit 30. The other configurations and processing of the distance measurement device 1 according to the first variation of the embodiment are the same as those of the distance measurement device 1 according to the embodiment.

In the first variation of the embodiment, the projection unit 30 includes a single light source 31. For example, the light source 31 is a white laser diode. The optical system 32 includes a collimator lens 326. The collimator lens 326 converts the light emitted from the light source 31 into parallel light. The other configurations of the projection unit 30 according to the first variation of the embodiment are the same as those of the projection unit 30 of the embodiment.

### <Output Characteristics of Light Source>

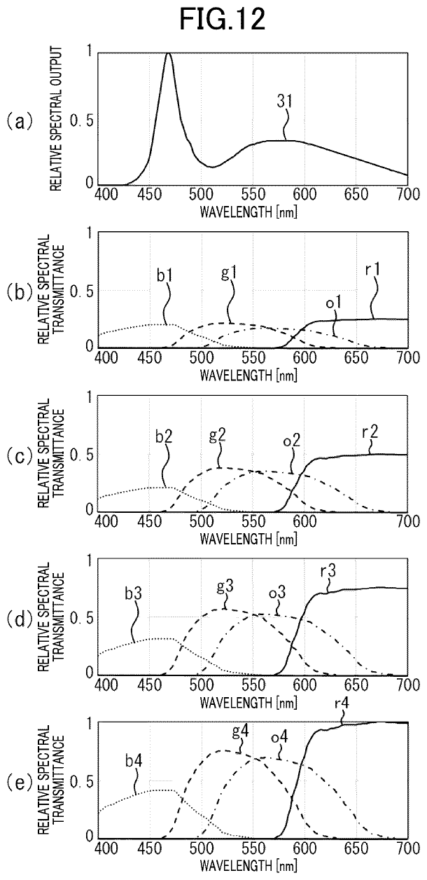

In FIG. 12, (a) is a graph illustrating as an example an output (spectral output) of the light source 31 according to the first variation of the embodiment. The output of the light output from the single light source 31 changes in accordance with a change in the wavelength.

Specifically, the output of the light gradually increases from the minimum level (zero) to the maximum level as the wavelength of the light increases from 430 nm to 470 nm; and the output of the light gradually decreases from the maximum level to “about 0.2 times the maximum level” as the wavelength of the light increases from 470 nm to 510 nm. The output of the light gradually increases from “about 0.2 times the maximum level” to “about 0.4 times the maximum level” as the wavelength of the light increases from 510 nm to 580 nm; and the output of the light gradually decreases from “about 0.4 times the maximum level” to the minimum level as the wavelength of the light increases from 580 nm.

### <Transmittance Characteristics of Narrow-Area Filter Region>

In FIG. 12, (b) to (e) are graphs illustrating as examples transmittance characteristics of the first to fourth narrow-area filter regions 621 to 624 according to the first variation of the embodiment. As shown in (b) to (e) of FIG. 12, according to the comparison among the respective hues, the levels of the transmittance for the transmitting wavelength ranges of the first to fourth narrow-area filter regions 621 to 624 can be regarded as being set to “levels 1 to 4,” respectively, in any hue.

As shown in (b) of FIG. 12, the transmittance for the transmitting wavelength range of the first narrow-area filter region 621 is set for each hue in accordance with the output characteristics of the single light source 31 (i.e., a change in the output associated with a change in the wavelength of the light emitted from the single light source 31). In the example of (b) of FIG. 12, the transmittance of the first narrow-area filter region 621 (i.e., the transmittance for the transmitting wavelength range) whose transmitting wavelength range is set to the wavelength range corresponding to “red” is higher than the transmittance of the first narrow-area filter region 621 (i.e., the transmittance for the transmitting wavelength range) whose transmitting wavelength range is set to the wavelength range corresponding to “another hue.” By setting the transmittance for the transmitting wavelength range of the first narrow-area filter region 621 for each hue in accordance with the output characteristics of the single light source 31 in this manner, it is possible to make the level of luminance of the first narrow-area light region 521 generated by the first narrow-area filter region 621 be the same level (level 1) in any hue. The same applies to the second to fourth narrow-area filter regions 622 to 624.

### Second Variation of Embodiment

A distance measurement device 1 according to a second variation of the embodiment differs from the distance measurement device 1 according to the embodiment in the configurations of the pattern light 50 and the filter 33. The other configurations and processing of the distance measurement device 1 according to the second variation of the embodiment are the same as those of the distance measurement device 1 according to the embodiment.

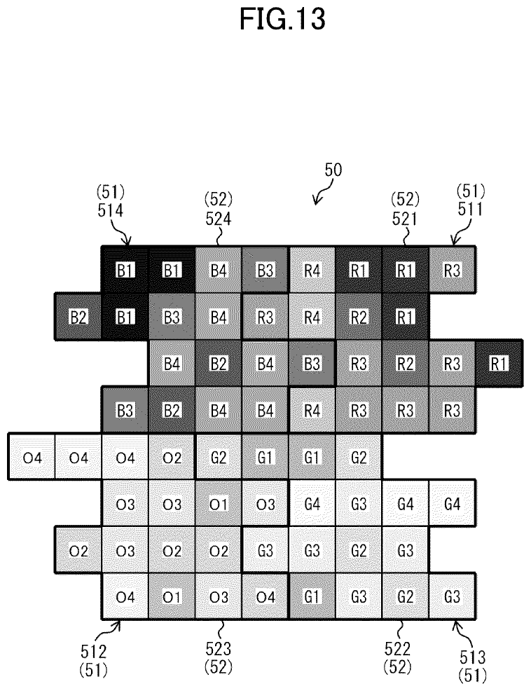

FIG. 13 illustrates as an example a part of pattern light 50 according to the second variation of the embodiment. In the pattern light 50 according to the second variation of the embodiment, the shape of the wide-area light region 51 is in a different shape from the shape (a rectangle) of the narrow-area reference block B12. The arrangement (distribution pattern) of the wide-area light regions 51 in the pattern light 50 is the same as the arrangement of the wide-area light regions 51 in the pattern light 50 according to the embodiment (see FIG. 6). The configuration (shape) and arrangement (distribution pattern) of the narrow-area light regions 52 included in each of the plurality of wide-area light regions 51 are the same as those of the narrow-area light regions 52 in the pattern light 50 according to the embodiment (see FIG. 6).

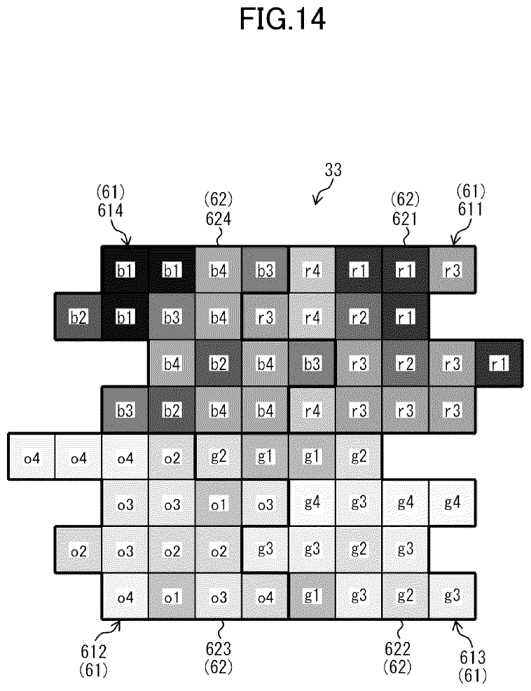

FIG. 14 illustrates as an example a part of the filter 33 according to the second variation of the embodiment. In the filter 33 according to the second variation of the embodiment, the shape of the wide-area filter region 61 is a shape corresponding to the shape of the wide-area light region 51 shown in FIG. 13 and a different shape from the shape (a rectangle) of the narrow-area reference block B12. The arrangement (distribution pattern) of the wide-area filter regions 61 in the filter 33 is the same as the arrangement of the wide-area filter regions 61 in the filter according to the embodiment (see FIG. 7). The configuration (shape) and arrangement (distribution pattern) of the narrow-area filter regions 62 included in each of the plurality of wide-area filter regions 61 are the same as those of the narrow-area filter regions 62 in the filter 33 according to the embodiment (see FIG. 7).

### Third Variation of Embodiment

A distance measurement device 1 according to a third variation of the embodiment differs from the distance measurement device 1 according to the embodiment in the first search processing by the controller 40 (i.e., the first search unit 411).

In the third variation of the embodiment, the first search unit 411 performs reduction processing on the wide-area reference block B11. The reduction processing is for reducing the data amount. The first search unit 411 performs the reduction processing on the wide-area referenced block BR1. Based on the wide-area reference block B11 and the wide-area referenced block BR1 subjected to the reduction processing, the first search unit 411 derives the similarity between the wide-area reference block B11 and the wide-area referenced block BR1. Examples of the reduction processing include thinning processing and binning processing.

### [Advantages of Third Variation of Embodiment]

As described above, in the distance measurement device 1 according to the third variation of the embodiment, the first search unit 411 derives the similarity between the wide-area reference block B11 and the wide-area referenced block BR1 based on the wide-area reference block B11 and the wide-area referenced block BR1 subjected to the reduction processing.

According to this configuration, it is possible to shorten the time required for deriving the similarity between the wide-area reference block B11 and the wide-area referenced block BR1 and thus increase the speed of the first search processing (i.e., search by the first search unit 411). It is thus possible to increase the speed in measuring the distance D0 by the distance measurement device 1.

### Application Example of Distance Measurement Device

The distance measurement device 1 described above is installed in, for example, an end effector (e.g., a grip, not shown) of a robot arm for a work operation in a factory. In this case, the controller 40 of the distance measurement device 1 receives, from a robot controller (not shown), an instruction to obtain a distance via the communication interface 42 in the work process of the robot arm. In response to this instruction, the controller 40 (the measurement unit 404) measures the distance between the position of the end effector and a surface of the object OB that is a target of work, and transmits a result of measurement (distance information) to the robot controller via the communication interface. The robot controller performs feedback control on the operation of the end effector, based on the distance information received from the distance measurement device 1. If the distance measurement device 1 is installed in the end effector, the distance measurement device 1 is desirably small and lightweight.

### Other Embodiments

While an example has been described in which the wide-area reference block B11 is a pixel block including 36 pixels in a matrix of six rows and six columns, the configuration is not limited thereto. The wide-area reference block B11 may be in another shape and size. The same applies to the wide-area referenced block BR1, the narrow-area reference block B12, and the narrow-area referenced block BR2.

While an example has been described in which the number of imaging units is two (an example of including the first imaging unit 10 and the second imaging unit 20), the configuration is not limited thereto. The distance measurement device 1 may include three or more imaging units. In this case, these imaging units are arranged such that their visual fields overlap one another, and the pattern light 50 is projected on the area where the visual fields overlap one another.

While an example has been described in which the number of types of the wide-area light region 51 included in the pattern light 50 is four, the configuration is not limited thereto. There may be two, three, five, or more types of the wide-area light regions 51. The same applies to the types of the wide-area filter regions 61 included in the filter 33.

While an example has been described in which the number of types of the narrow-area light regions 52 included in each of the plurality of wide-area light regions 51 in the pattern light 50 is four, the configuration is not limited thereto. There may be two, three, five, or more types of the narrow-area light regions 52. The same applies to the types of the narrow-area filter regions 62 included in each of the plurality of wide-area filter regions 61 of the filter 33.

While an example has been described in which the filter 33 is a transmissive filter, the type is not limited to thereto. For example, the filter 33 may be a reflective filter.

In the above description, the plurality of narrow-area light regions 52 included in the pattern light 50 may include a narrow-area light region 52 whose luminance is zero (a no-light dot). The plurality of narrow-area filter regions 62 included in the filter 33 may include a narrow-area filter region 62 that does not transmit and blocks light (a narrow-area filter region 62 that forms a no-light dot).

While an example has been described in which the distance measurement device 1 is installed in an end effector of the robot arm, the configuration is not limited thereto. For example, the distance measurement device 1 may be applied to another system that performs predetermined control based on the distance D0 to a surface to be measured (e.g., a surface of the object OB).

The configuration of the distance measurement device 1 is not limited to the configuration in the above description. For example, the first imaging element 12 and the second imaging element 22 may be each a photosensor array including a plurality of photosensors arranged in a matrix.

In the above description, the components of the distance measurement device 1 may be collectively arranged as one device, or may be distributed into a plurality of devices (e.g., a plurality of devices that communicate with each other via a communication network such as the Internet). The controller 40 may be implemented by one processor or may be implemented by a plurality of processors. The controller 40 may be implemented by a plurality of arithmetic processing devices (e.g., a plurality of arithmetic processing devices that communicate with each other via a communication network such as the Internet).

The embodiment and variations described above may be combined and implemented as appropriate. The embodiment and variations described above are mere preferred examples in nature, and not intended to limit the technique disclosed herein, the scope, applications, or use of the disclosure.

### INDUSTRIAL APPLICABILITY

As described above, the technique disclosed herein is useful as a distance measurement technique.

### DESCRIPTION OF REFERENCE CHARACTERS

1 Distance Measurement Device
10 First Imaging Unit
20 Second Imaging Unit
30 Projection Unit
31 Light Source
32 Optical System
33 Filter
40 Controller
401 First Imaging Processing Unit
402 Second Imaging Processing Unit
403 Projection Control Unit
404 Measurement Unit
411 First Search Unit
412 Second Search Unit
413 Distance Derivation Unit
50 Pattern Light
51 Wide-Area Light Region
52 Narrow-Area Light Region
61 Wide-Area Filter Region
62 Narrow-Area Filter Region

1. A distance measurement device comprising:
a first imaging unit and a second imaging unit aligned so that visual fields of the first imaging unit and the second imaging unit overlap each other;
a projection unit configured to project pattern light on an area in which the visual field of the first imaging unit and the visual field of the second imaging unit overlap each other; and
a measurement unit configured to measure a distance to a surface to be measured onto which the pattern light is projected, based on a parallax between a first image obtained by the first imaging unit and a second image obtained by the second imaging unit,
the pattern light being pattern light whih includes a plurality of light regions with different hues and a plurality of light regions with the same hue and different levels of luminance, and in which a plurality of wide-area light regions are distributed in a predetermined pattern and a plurality of narrow-area light regions are distributed in another predetermined pattern in each of the plurality of wide-area light regions.

2. The distance measurement device of claim 1, wherein
the projection unit includes a filter for generating the pattern light,
the filter includes a plurality of wide-area filter regions including a plurality of filter regions for generating the plurality of light regions with different hues and a plurality of filter regions for generating the plurality of light regions with the same hue and different levels of luminance, the plurality of wide-area filter regions being distributed in the same pattern as the predetermined pattern so as to correspond respectively to the plurality of wide-area light regions, and
each of the plurality of wide-area filter regions includes a plurality of narrow-area filter regions distributed in the same pattern as the other predetermined pattern so as to correspond respectively to the plurality of narrow-area light regions included in the wide-area light region, out of the plurality of wide-area light regions, which corresponds to that wide-area filter region.

3. The distance measurement device of claim 2, wherein
the projection unit includes:
a light source; and
an optical system configured to guide, to the filter, light emitted from the light source.

4. The distance measurement device of claim 3, wherein
each of the plurality of filter regions for generating the plurality of light regions with different hues extracts light in a wavelength range corresponding to the plurality of light regions with different hues from the light emitted from the light source, and
each of the plurality of filter regions for generating the plurality of light regions with the same hue and different levels of luminance extracts, from the light emitted from the light source, light in a wavelength range corresponding to the plurality of light regions with the same hue and different levels of luminance by an amount corresponding to the luminance.

5. The distance measurement device of claim 4, comprising:
a projection control unit configured to adjust luminance of the light emitted from the light source so that the luminance of the light emitted from the light source is not saturated.

6. The distance measurement device of claim 1, wherein
the plurality of wide-area light regions include the plurality of light regions with different hues and are distributed in a predetermined hue pattern, and
the plurality of narrow-area light regions include the plurality of light regions with the same hue and different levels of luminance and are distributed in a predetermined luminance pattern.

7. The distance measurement device of claim 1, wherein
the measurement unit includes:
a first search unit configured to sequentially select a wide-area reference block from the first image and search the second image for a wide-area corresponding block corresponding to the wide-area reference block;
a second search unit configured to sequentially select a narrow-area reference block from the wide-area reference block and search the wide-area corresponding block corresponding to the wide-area reference block for a narrow-area corresponding block corresponding to the narrow-area reference block; and
a distance derivation unit configured to derive a distance to the surface to be measured in relation to the narrow-area reference block, based on a difference in position between the narrow-area reference block and the narrow-area corresponding block.

8. The distance measurement device of claim 7, wherein
the first search unit sequentially selects the wide-area reference block from the first image by moving a pixel area, which is for selecting the wide-area reference block, by a first reference amount of movement in the first image,
the second search unit sequentially selects the narrow-area reference block from the wide-area reference block by moving a pixel area, which is for selecting the narrow-area reference block, by a second reference amount of movement in the wide-area reference block, and
the first reference amount of movement is larger than the second reference amount of movement.

9. The distance measurement device of claim 7, wherein
the first search unit sequentially selects a wide-area referenced block from the second image by moving a pixel area, which is for selecting the wide-area referenced block as a candidate for the wide-area corresponding block, by a first referenced amount of movement in the second image,
the second search unit sequentially selects a narrow-area referenced block from the wide-area corresponding block by moving a pixel area, which is for selecting the narrow-area referenced block as a candidate for the narrow-area corresponding block, by a second referenced amount of movement in the wide-area corresponding block, and
the first referenced amount of movement is larger than the second referenced amount of movement.

10. The distance measurement device of claim 7, wherein
the first search unit
sequentially selects, from the second image, a wide-area referenced block as a candidate for the wide-area corresponding block corresponding to the wide-area reference block, and determines the wide-area referenced block having a maximum similarity with the wide-area reference block, among the wide-area referenced blocks sequentially selected from the second image, to be the wide-area corresponding block, and
performs reduction processing for reducing an amount of data on the wide-area reference block and the wide-area referenced block, and derives a similarity between the wide-area reference block and the wide-area referenced block, based on the wide-area reference block and the wide-area referenced block subjected to the reduction processing.

11. A distance measurement method using:
a first imaging unit and a second imaging unit aligned so that visual fields of the first imaging unit and the second imaging unit overlap each other; and a projection unit configured to project pattern light on an area in which the visual field of the first imaging unit and the visual field of the second imaging unit overlap each other, the distance measurement method comprising:
projecting the pattern light from the projection unit;
obtaining a first image obtained by the first imaging unit and a second image obtained by the second imaging unit; and
measuring a distance to a surface to be measured onto which the pattern light is projected, based on a parallax between the first image and the second image,
the pattern light being pattern light which includes a plurality of light regions with different hues and a plurality of light regions with the same hue and different levels of luminance, and in which a plurality of wide-area light regions are distributed in a predetermined pattern and a plurality of narrow-area light regions are distributed in another predetermined pattern in each of the plurality of wide-area light regions.

12. A distance measurement program for causing a computer to execute the distance measurement method of claim 11.
